(19) United States
(12) Patent Application Publication
(10) Pub. No.: US 2016/0091994 A1
(43) Pub. Date: Mar. 31, 2016

(54) USER INTERFACE FOR CONTROLLING A SOURCE PARAMETER AND CORRELATING A MEASUREMENT IN REAL-TIME

(71) Applicant: Keithley Instruments, Inc., Cleveland, OH (US)

(72) Inventor: F. Joseph Frese, IV, Cleveland, OH (US)

(21) Appl. No.: 14/711,572

(22) Filed: May 13, 2015

Related U.S. Application Data
(60) Provisional application No. 62/055,528, filed on Sep. 25, 2014.

(51) Int. Cl. G06F 3/0354; G06F 3/0488; G06F 3/0481; G06F 3/0484; G06F 3/041; G06F 3/01

(52) U.S. Cl. CPC G06F 3/03548; G06F 3/0412; G06F 3/017; G06F 3/04817; G06F 3/04847; G06F 3/0488; G06F 2203/04808

(57) ABSTRACT

A method including displaying an orthogonal grid on a touchscreen display. The touchscreen display is in communication with a test and measurement instrument. The orthogonal grid has an axis that is associated with a controlled output parameter of the test and measurement instrument. The method also includes detecting a touch input at the touchscreen display. The touch input includes a continuous slide gesture made by a user substantially along the axis of the orthogonal grid. The slide gesture begins at a first location on the axis and ends at a second location on the axis. Also, the method includes adjusting the controlled output parameter of the test and measurement instrument from an initial value to an adjusted value. The initial value corresponds to the first location of the slide gesture and the adjusted value corresponds to the second location of the slide gesture. Systems are also disclosed.

### CROSS-REFERENCES TO RELATED APPLICATIONS

This patent application claims the benefit of provisional Application No. 62/055,528 filed Sep. 25, 2014, which is incorporated in this patent application by this reference.

### FIELD OF THE INVENTION

This disclosure is generally directed to methods and systems for adjusting a parameter of a test and measurement instrument, particularly through a gesture at a touchscreen display.

### BACKGROUND

Traditionally, direct-current electrical instrumentation that includes both sourcing and measuring functionality has relied heavily on text-based interfaces: typically, a numeric value on a front panel display representing the source level and another representing the most recent measurement.

Advances in display technology have led to improvements in how measurements from these instruments are visually presented, leading to quicker insights by human operators. For example, some conventional source-measure units are capable of displaying measurements as points on a two-dimensional grid, graphing not only voltage vs. time—the defining feature of oscilloscopes—but also current vs. time and current vs. voltage. But to control the source on these conventional instruments, the user must enter the source value in a text field. This process is laborious and divorced from the graphical measurement display, distracting the user from the measurements. Also, on some conventional instruments, the measurement graph is not visible while the source control is being accessed.

Another example of a source-measure device is a conventional curve tracer. In this case, the controlled output parameter is not a steady-state voltage level, but a start voltage for a variable collector supply. Measurements are displayed as one or more current-voltage (I-V) curves that begin approximately at the start voltage along the x-axis, and end at the origin. The start voltage is adjusted using a physical knob. With one hand on the knob, the user can keep the user's eyes on the measurement and adjust the start voltage according to where the I-V curves end. Nonetheless, there are at least three shortcomings to this method.

First, the control point is not directly displayed on the measurement grid. Instead, it must be inferred from the active measurements. And if measurements are not active, the control point cannot be determined from the grid display area.

Second, the control knob itself is located apart from the display. So if the user's hand is not already on the knob, the user's attention must be diverted from the display to find the knob to adjust the start voltage.

Third, the control knob is a separate physical control. So the conventional adjustment method is not suited for modern mobile devices, such as smartphones and tablets, where a touchscreen is the only control interface (apart from an on/off button and a rocker, strongly associated with audio volume).

Embodiments of the invention address the shortcomings with the conventional systems.

### SUMMARY OF THE DISCLOSURE

The present application is generally directed to methods and systems for controlling an instrument by inputting a gesture on an axis of a graph, rather than turning a knob on an instrument as is conventionally done.

Thus, at least some embodiments of a method may include displaying an orthogonal grid on a touchscreen display. The touchscreen display is in communication with a test and measurement instrument. The orthogonal grid has an axis that is associated with a controlled output parameter of the test and measurement instrument. The method may also include detecting a touch input at the touchscreen display. The touch input includes a continuous slide gesture made by a user substantially along the axis of the orthogonal grid. The slide gesture begins at a first location on the axis and ends at a second location on the axis. Also, the method may include adjusting the controlled output parameter of the test and measurement instrument from an initial value to an adjusted value. The initial value corresponds to the first location of the slide gesture and the adjusted value corresponds to the second location of the slide gesture.

In another aspect, the method may include measuring a second parameter that is functionally related to the controlled output parameter and displaying, on the orthogonal grid, a data point having coordinates corresponding to the controlled output parameter and the second parameter.

In another aspect, at least some embodiments of a system may include a test and measurement instrument configured to output a controlled parameter and to adjust the controlled parameter within a range of values. The range of values include an initial value and an adjusted value. The system may also include a touchscreen display in communication with the test and measurement instrument. The touchscreen display may be configured to detect a slide gesture made by a user substantially along an axis of a grid displayed on the touchscreen display. The slide gesture begins at a first location on the axis and ends at a second location on the axis. The touchscreen display may further be configured to communicate to the test and measurement instrument information corresponding to the first location and the second location. Furthermore, the initial value of the controlled parameter may correspond to the first location of the slide gesture, and the adjusted value of the controlled parameter may correspond to the second location of the slide gesture.

In yet another aspect of the system, the test and measurement instrument may further be configured to measure a second parameter that is functionally related to the controlled parameter. Also, the touchscreen display may further be configured to display, on the grid, a data point with coordinates corresponding to the controlled parameter and the second parameter.

These and other features, aspects, and advantages of the disclosed subject matter will become better understood with reference to the following description, appended claims, and accompanying drawings of embodiments of the invention.

### BRIEF DESCRIPTION OF THE DRAWINGS

FIG. 1 is a diagram of a system including a mobile device with a touchscreen display and a test and measurement instrument also having a touchscreen display.

FIG. 2 is a representation of an orthogonal grid displayed on a touchscreen display.

FIG. 3 is the representation of FIG. 2, in which the controlled output parameter has been changed.

FIG. 4 is the representation of FIG. 3 but also including an example of a data point.

FIG. 5 is a representation of an orthogonal grid that includes a series of data points.

FIG. 6 is a functional block diagram of a system having a touchscreen display and a test and measurement instrument.

FIG. 7 is a flowchart of a method of adjusting a controlled output parameter of a test and measurement instrument with a touchscreen display.

### DETAILED DESCRIPTION

As described herein, embodiments of the invention are directed to methods and systems for controlling an instrument by utilizing a slide gesture on a touchscreen display. The disclosed concepts apply to any instrument that features a controlled output parameter, or source parameter, and an associated measurement. Thus, the described methods and devices could be implemented for a curve trace measurement on a source-measure unit, a graph of bit error rate versus frequency on a bit error rate tester, systems of instruments that have the measurement and source functions split between components (such as a power supply and a separate digital multimeter), or any other such devices and systems.

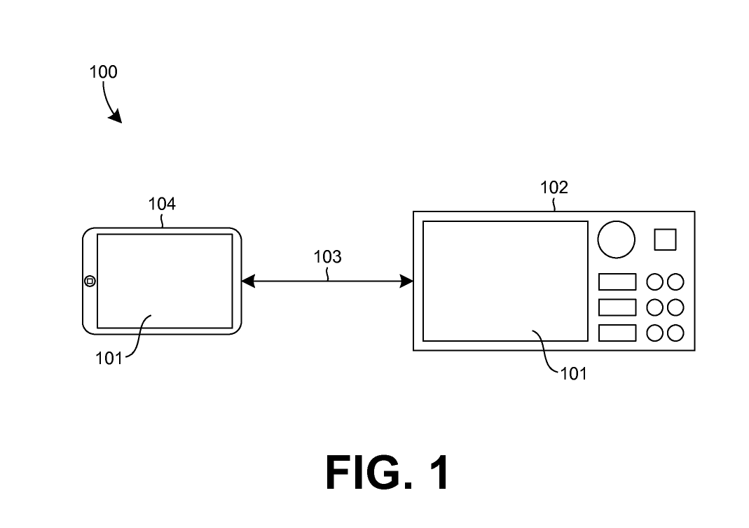

FIG. 1 is a diagram of a system 100 including a touchscreen display 101 and a test and measurement instrument 102, according to embodiments. There may be a communication link 103 between the touchscreen display 101 and the test and measurement instrument 102. The communication link 103 could be wired, such as by universal serial bus (USB) connections, or wireless, such as by radio frequency or infrared signals.

The touchscreen display 101 may be any touchscreen that supports gestures. For example, the touchscreen display 101 could be an integral part of a mobile device 104, such as a smartphone or a tablet, that is remote, or apart, from the test and measurement instrument 102. As another example, the touchscreen display 101 could be an integral part of, or embedded in, the test and measurement instrument 102. In versions where the touchscreen display 101 is part of the test and measurement instrument 102, the system might not include the mobile device 104.

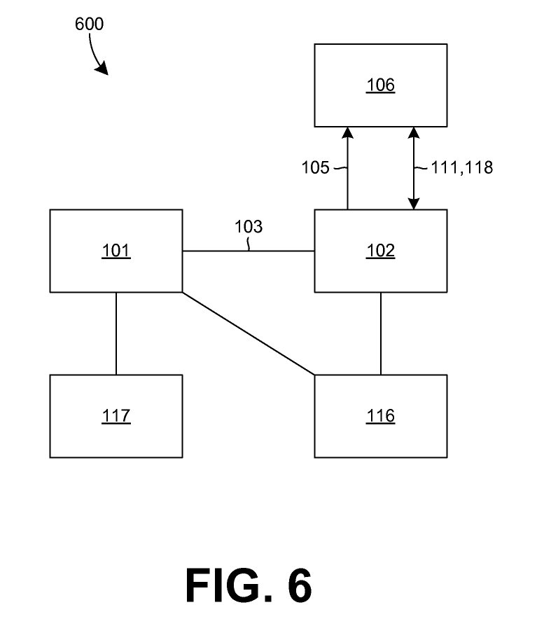

The test and measurement instrument 102 outputs a controlled output parameter 105, for example, to a device under test 106 as shown in FIG. 6. The controlled output parameter could be constant, or it could vary with respect to time or another property. As examples, the controlled output parameter may be a voltage or a current.

The test and measurement instrument 102 may be, for example, a source-measure unit or a bit error rate tester. If the test and measurement instrument 102 is a source-measure unit, the controlled output parameter may be, for example, a voltage or a current. If the test and measurement instrument 102 is a bit error rate tester, the controlled output parameter may be, for example, a voltage pattern. Other configurations are also possible. Thus, the test and measurement instrument 102 may include multiple instruments, such as a power supply outputting a voltage or current and a digital multimeter measuring values related to that voltage or current.

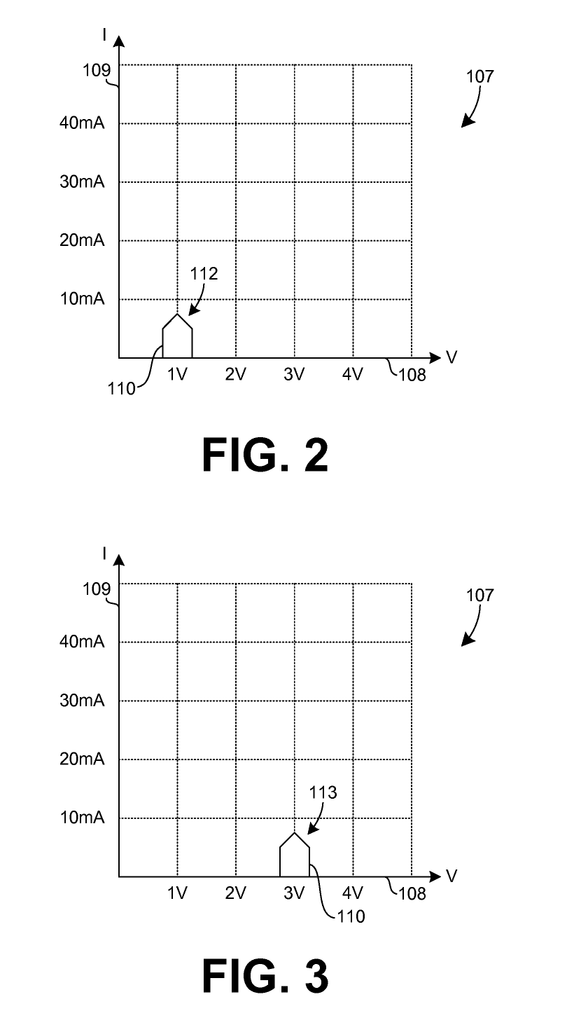

FIGS. 2 and 3 are examples of an orthogonal grid 107 displayed on the touchscreen display 101. The orthogonal grid 107 may be a two-dimensional coordinate grid and may include an x-axis 108, a y-axis 109, and a slider icon 110.

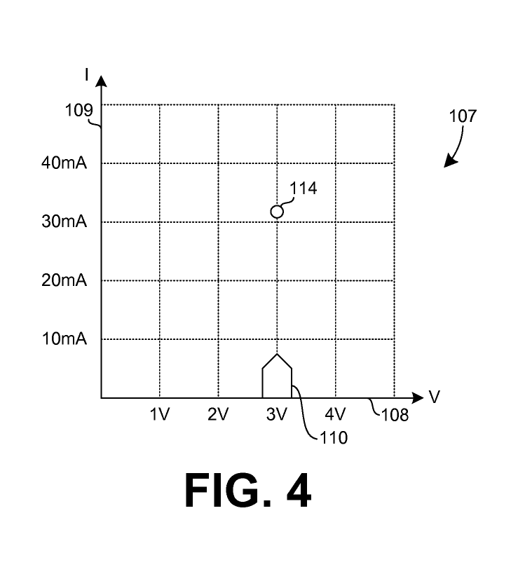

The x-axis 108 and the y-axis 109 could indicate any set of units. For example, the indicated units could be volts and milliamperes as shown in FIG. 2. One of the axes, either the x-axis 108 or the y-axis 109, is associated with the controlled output parameter, or the instrument source. The other axis is associated with a second parameter, or the instrument measurements. In FIGS. 2 and 3, the x-axis 108 is the axis associated with the controlled output parameter, and the y-axis 109 is the axis associated with the second parameter. The second parameter is described below in relation to FIG. 4.

The slider icon 110 may be a visual indicator of a setting level for the controlled output parameter. Accordingly, the slider icon 110 is preferably positioned on the axis associated with the controlled output parameter. For example, as shown in FIG. 2, the slider icon 110 is positioned on the x-axis 108 and indicates that the controlled output parameter is set at approximately one volt (1 V). By comparison, the slider icon 110 in FIG. 3 indicates that the controlled output parameter is set at approximately three volts (3 V) instead of one volt (1 V).

The user may move the slider icon 110 by way of a touch input. Preferably, the touch input is a slide gesture made by a user substantially along the x-axis 108 or the y-axis 109 of the orthogonal grid 107 displayed on the touchscreen display 101. The slide gesture is preferably performed on the axis associated with the controlled output parameter of the test and measurement instrument 102. The slide gesture begins at a first location 112 on the axis and ends at a second location 113 on the axis.

Preferably, the slide gesture is continuous. In this context, “continuous” means that the user, when making the slide gesture, does not lift the user's finger or stylus from the touchscreen display 101 between the first location 112 and the second location 113. To put this another way, continuous means that the processor 117, described below, does not detect a finger lift or a stylus lift between the first location 112 and the second location 113.

Through the use of the slide gesture on the touchscreen display 101, the controlled output parameter of the test and measurement instrument 102 may be adjusted from an initial value to an adjusted value. The initial value can correspond to the first location 112 of the slide gesture and the adjusted value can correspond to the second location 113 of the slide gesture. As the user performs the slide gesture, the slider icon 110 may move from the first location 112 to the second location 113 on the touchscreen display 101.

For example, in FIG. 2, the slider icon 110 is at 1 V on the x-axis 108, which is the axis associated with the controlled output parameter in this example. Suppose the user utilizes the slide gesture to drag the slider icon 110 from the 1 V mark to the 3 V mark so that the result is as displayed in FIG. 3. The user may do this by touching the slider icon 110 at the 1 V mark with the user's finger or a stylus, sliding the slider icon 110 to the 3 V mark by moving the user's finger or the stylus across the touchscreen display 101 from the 1 V mark to the 3 V mark, and then lifting the user's finger or the stylus off of the touchscreen display 101. Thus, in this example, when the slider icon 110 is at the 1 V mark, that is the first location 112 of the slide gesture. Likewise, when the slider icon 110 is at the 3 V mark in this example, that is the second location 113 of the slide gesture.

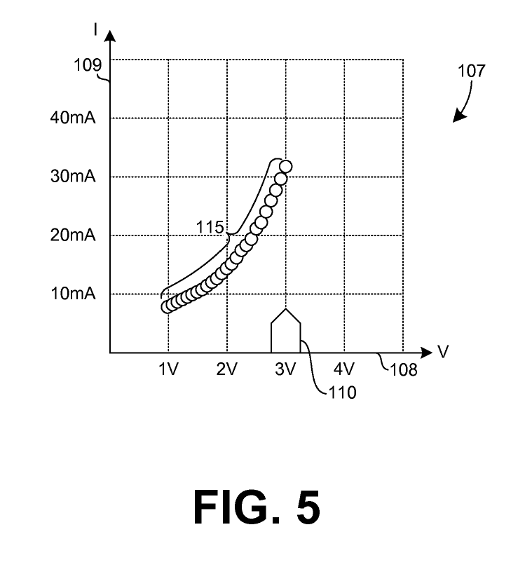

As a result of the slide gesture, the touchscreen display 101 may send a command to the test and measurement instrument 102 to change the controlled output parameter. In the example being discussed, the command may be to change the controlled output parameter from one volt to three volts. The test and measurement instrument 102, upon receiving the command, changes the controlled output parameter from an initial value of one volt to an adjusted value of three volts, in accordance with the command The command may be sent once, for example when the slide gesture is completed. Or multiple commands may be sent periodically or continuously as the slide gesture is performed by the user or recognized by the touchscreen display 101. This is also discussed below with regard to FIG. 5.

As part of the command, the touchscreen display 101 may communicate information corresponding to the first location 112 and the second location 113. The information may include, for example, the setting levels corresponding to the first location 112 and the second location 113. With reference to FIGS. 2 and 3, those setting levels are 1 V and 3 V, respectively, for the depicted examples. The information might also include the difference between the setting levels corresponding to the first location 112 and the second location 113 as well as a relative direction. The relative direction may be, for example, whether the second location 113 is to the left or right of the first location 112 or whether the corresponding setting level of the second location 113 is greater or less than the corresponding setting level of the first location 112.

When the command is sent periodically or continuously as the slide gesture is performed or recognized, the information may include the setting levels corresponding to a plurality of locations between the first location 112 and the second location 113. Conceptually, this can be viewed as if the second location is continuously changing, along with the slide gesture, as the slide gesture moves away from the first location 112. Thus, in the example of FIGS. 2 and 3, the information may include the setting levels corresponding to a plurality of locations between 1 V and 3 V. An example of this is shown in FIG. 5, which is discussed below.

In some embodiments, the orthogonal grid 107 does not include the slider icon 110. Even so, in such embodiments the user may still utilize a touch input, such as the slide gesture, to adjust the controlled output parameter.

FIG. 4 is an example of an orthogonal grid 107 displayed on the touchscreen display 101. The grid may include an x-axis 108, a y-axis 109, a slider icon 110, and a data point 114. The x-axis 108, the y-axis 109, and the slider icon 110 are generally as described above for FIGS. 2 and 3. In FIG. 4, the x-axis 108 is the axis associated with the controlled output parameter, and the y-axis 109 is the axis associated with the second parameter. The description here follows this convention even though, as noted above, the axes could be reversed such that the x-axis 108 may be associated with the second parameter and the y-axis 109 may be associated with the controlled output parameter.

The data point 114 has coordinates corresponding to the controlled output parameter and the second parameter. The second parameter is explained below. In this way, the controlled output parameter and the second parameter may both be visible on the same grid at the same time.

With reference to FIG. 4, the x-coordinate is the value of the controlled output parameter. This value may be the setting level for the controlled output parameter, or the value may be the read-back measurement of the controlled output parameter. That is, if the slider icon 110 is positioned at, for example, 3 V or if the controlled output parameter is otherwise set at 3 V, then the x-coordinate may reflect the 3 V setting level for the controlled output parameter.

Continuing with that example, if the controlled output parameter is set at 3 V, the x-coordinate may instead be a measured read-back, or actual, value of the outputted amount. The read-back amount, as measured by the test and measurement instrument 102, may be less than or greater than the 3 V setting level. This could happen if, for example, the actual output level does not precisely track the setting level. In such cases, the measured actual level, or read-back amount, may be more accurate than using the setting level. A variation can also happen if the configuration of the test and measurement instrument 102 does not allow for the setting level to be the actual amount that is output. Since a user sometimes does not realize that the configuration is limiting the actual amount, it may benefit the user to display the coordinate of the actual amount instead of the setting level. For example, the output amount may be limited by the configuration to be no greater than 2 V; so a setting level of 3 V may not result in an actual output of 3 V. Instead, the actual output may be greater than or less than 3 V. Accordingly, for a setting level of 3 V, the read-back value might be 2.97 V if for example, the actual output level does not precisely track the setting level. Alternatively, for a setting level of 3 V, the read-back value might be 2.00 V if, for example, the configuration of the test and measurement instrument 102 limits the output amount to be no greater than 2 V. The values used here are to explain the concepts and are only examples of values that could be possible in some embodiments.

With further reference to FIG. 4, the y-coordinate can be the value of the second parameter or may otherwise correspond to the second parameter. The second parameter may be functionally related to, or otherwise correlated with, the controlled output parameter. For example, if the controlled output parameter is a voltage, then the second parameter may be a current that results from applying the voltage to a device under test 106. As another example, the second parameter may be time and the controlled output parameter may be current or voltage.

The data point 114 may be plotted before the controlled output parameter is changed, for example, by using the initial value of the controlled output parameter and the corresponding second parameter. The data point 114 may also be plotted after the controlled output parameter is changed, for example, by using the adjusted value of the controlled output parameter and the corresponding second parameter. In some embodiments, the data point 114 is plotted both before and after the controlled output parameter is changed.

The measurements discussed in this application, including the read-back value and the value of the second parameter, may be made by the test and measurement instrument 102. The measurements may be periodically made according to a preset time interval, and the test and measurement instrument 102 may periodically communicate the measured values to the touchscreen display 101. The communication may be in real time, substantially contemporaneous with the measuring, and the communication may occur via the communication link 103. In some embodiments, the touchscreen display 101 may periodically request measured values, including the read-back value and the value of the second parameter, from the test and measurement instrument 102 at a preset interval. Otherwise, the touchscreen display 101 may request measurement values along with the command to change the controlled output parameter as the slider icon 110 is dragged or the slide gesture is made by the user.

FIG. 5 is an example of an orthogonal grid 107 displayed on the touchscreen display 101. The grid may include an x-axis 108, a y-axis 109, a slider icon 110, and a series of data points 115. The x-axis 108, the y-axis 109, and the slider icon 110 are generally as described above for FIGS. 2 and 3. In FIG. 5, the x-axis 108 is the axis associated with the controlled output parameter and the y-axis 109 is the axis associated with the second parameter, although the axes may be reversed in some embodiments as discussed above.

The series of data points 115 may result from a substantially continuous or periodic measurement or acquisition of the read-back value, the value of the second parameter, or both. With specific reference to FIG. 5, for example, and following the procedures described above, the user may change the controlled output parameter from an initial value of one volt to an adjusted value of three volts by sliding the slider icon 110 from 1 V to 3 V on the x-axis 108. As the controlled output parameter is adjusted from one volt to three volts, the touchscreen display 101 may acquire the read-back value, the value of the second parameter, or both for the initial value of the controlled output parameter, the adjusted value of the controlled output parameter, and one or more values between the initial value and the adjusted value. The number and spacing of the values depends on whether the acquisition is substantially continuous or periodic and, if periodic, what the time interval is. FIG. 5 is an example of values that are substantially continuous because there is no discernible space between the values within the series of data points 115.

Additionally, the touchscreen display 101, the test and measurement instrument 102, or both may include or be connected to a memory 116 (see FIG. 6) to store the values, including the read-back value, the setting level, the value of the second parameter, and the one or more values between the setting level and the value of the second parameter. And the stored values may be used to depict the series of data points 115 on the touchscreen display 101. Instead of, or in addition to, depicting the series of data points 115, the touchscreen display 101 may also draw a curve representing the series of data points 115.

FIG. 6 is a functional block diagram of a system 600, which may include a touchscreen display 101, a test and measurement instrument 102, a processor 117, and a memory 116. The touchscreen display 101 and the test and measurement instrument 102 may be connected by the communication link 103. The test and measurement instrument 102 may be connected to a device under test 106, to which the controlled output parameter 105 may be sent. Additionally, the test and measurement instrument 102 may take or acquire measurements or other information about the second parameter 111 from the device under test 106, for example, via a connection 118. The connection 118 could be a testing probe.

The touchscreen display 101 and the test and measurement instrument 102 are generally as described above. As noted, the test and measurement instrument 102 may include multiple instruments, such as a power supply and a digital multimeter.

Additionally, the touchscreen display 101 might include or be connected to the processor 117, such as a microprocessor, to detect and interpret the touch input and to control the display of data on the touchscreen display 101. This could be a single processor or multiple processors. Furthermore, the touchscreen display 101, the test and measurement instrument 102, or both may include or be connected to the memory 116, which could be one or more computer memory 116 locations or devices. As noted above, the memory 116 may store the values used to depict the series of data points 115 on the touchscreen display 101.

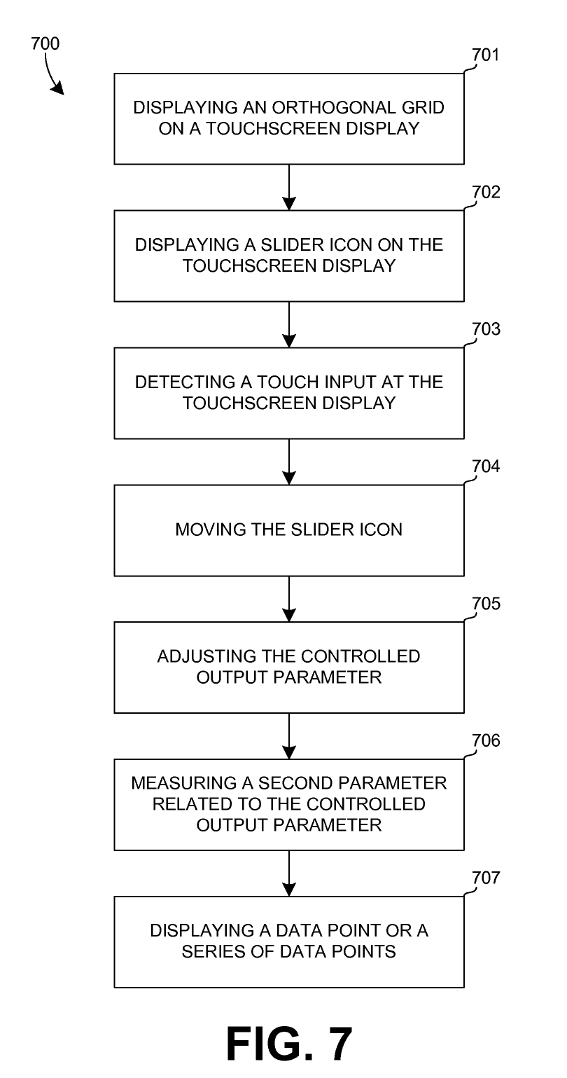

FIG. 7 is a flowchart of a method embodiment 700 of adjusting a controlled output parameter of a test and measurement instrument with a touchscreen display. Not all of the depicted operations are required in each embodiment of the method. Moreover, unless otherwise indicated, the operations need not be performed in the order shown in FIG. 7 for all embodiments. The features and operations of the method are generally as described above, but with the following additional descriptions.

The method 700 may include displaying 701 an orthogonal grid on a touchscreen display. Also, the method 700 may include detecting 703 a touch input at a touchscreen display and adjusting 705 the controlled output parameter of the test and measurement instrument. The touch input preferably is a continuous slide gesture as described above. The method 700 could also include measuring 706 a second parameter related to the controlled output parameter and displaying 707 a data point having coordinates corresponding to the controlled output parameter and the second parameter. The data point could be a series of data points having coordinates continuously corresponding to the controlled output parameter and the second parameter as the controlled output parameter is continuously adjusted. In some embodiments, the series of data points are displayed substantially contemporaneously to the slide gesture being made from the first location to the second location.

The method 700 could also include displaying 702 a slider icon on the touchscreen display and moving 704 the slider icon from the first location to the second location, as the slide gesture is made from the first location to the second location.

In some embodiments, a non-transitory computer-readable medium may have computer-executable instructions stored on it that, in response to execution by a computing device, may cause the computing device to perform certain operations. Those operations may include the methods disclosed in this application, including the method embodiment 700 and operations within the method embodiment 700.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Although specific embodiments of the invention have been illustrated and described for purposes if illustration, it will be understood that various modifications may be made without departing from the spirit and scope of the invention. Accordingly, the invention should not be limited except as by the appended claims.

1. A method comprising:
displaying, on a touchscreen display in communication with a test and measurement instrument, an orthogonal grid having an axis associated with a controlled output parameter of the test and measurement instrument;
detecting a touch input at the touchscreen display, the touch input comprising a continuous slide gesture made by a user substantially along the axis of the orthogonal grid, the slide gesture beginning at a first location on the axis and ending at a second location on the axis; and
adjusting, with the test and measurement instrument, the controlled output parameter of the test and measurement instrument from an initial value to an adjusted value, the initial value corresponding to the first location of the slide gesture and the adjusted value corresponding to the second location of the slide gesture.

2. The method of claim 1, further comprising:
measuring, with the test and measurement instrument, a second parameter that is functionally related to the controlled output parameter; and
displaying, on the orthogonal grid, a data point having coordinates corresponding to the controlled output parameter and the second parameter.

3. The method of claim 1, in which the adjusting further comprises continuously adjusting the controlled output parameter of the test and measurement instrument as the slide gesture is made from the first location to the second location.

4. The method of claim 3, further comprising:
measuring, with the test and measurement instrument, a second parameter that is functionally related to the controlled output parameter; and
displaying, on the orthogonal grid, a series of data points having coordinates continuously corresponding to the controlled output parameter and the second parameter as the controlled output parameter is continuously adjusted.

5. The method of claim 4, in which the displaying the series of data points is substantially contemporaneous with the slide gesture being made from the first location to the second location.

6. The method of claim 1, further comprising:
displaying, on the touchscreen display, a slider icon at the first location; and
moving the slider icon, on the touchscreen display, from the first location to the second location, as the slide gesture is made from the first location to the second location.

7. A non-transitory computer-readable medium having computer-executable instructions stored thereon that, in response to execution by a computing device, cause the computing device to perform operations, the operations comprising the method of claim 1.

8. A system comprising:
a test and measurement instrument configured to output a controlled parameter and to adjust the controlled parameter within a range of values, the range of values including an initial value and an adjusted value; and
a touchscreen display in communication with the test and measurement instrument, the touchscreen display being configured to detect a slide gesture made by a user substantially along an axis of a grid displayed on the touchscreen display, the slide gesture beginning at a first location on the axis and ending at a second location on the axis, the touchscreen display further being configured to communicate to the test and measurement instrument information corresponding to the first location and the second location,
in which the initial value of the controlled parameter corresponds to the first location of the slide gesture and the adjusted value of the controlled parameter corresponds to the second location of the slide gesture.

9. The system of claim 8, in which the test and measurement instrument is a source-measurement unit and the controlled parameter is a voltage or a current.

10. The system of claim 8, in which the test and measurement instrument is a bit error rate tester.

11. The system of claim 8, in which the touchscreen display is in communication with the test and measurement instrument via a wireless connection.

12. The system of claim 8, in which the touchscreen display is in communication with the test and measurement instrument via a universal serial bus (USB) connection.

13. The system of claim 8, in which the touchscreen is an integral part of a mobile device that is remote from the test and measurement instrument.

14. The system of claim 8, in which the touchscreen is an integral part of the test and measurement instrument.

15. The system of claim 8, in which:
the test and measurement instrument is further configured to measure a second parameter that is functionally related to the controlled parameter; and
the touchscreen display is further configured to display, on the grid, a data point with coordinates corresponding to the controlled parameter and the second parameter.
